(19) United States
(12) Patent Application Publication
(10) Pub. No.: US 2014/0273768 A1
(43) Pub. Date: Sep. 18, 2014

(54) WATERJET SYSTEMS HAVING SECTIONAL CATCHER TANKS AND RELATED DEVICES, SYSTEMS AND METHODS

(71) Applicant: OMAX Corporation, Kent, WA (US)

(72) Inventors: Brian K. Guglielmetti, Bonney Lake, WA (US); Wade J. Doll, Seattle, WA (US)

(21) Appl. No.: 13/844,693

(22) Filed: Mar. 15, 2013

(51) Int. Cl. B26F 3/00

(52) U.S. Cl. CPC B26F 3/008
USPC 451/87

(57) ABSTRACT

Waterjet systems having sectional catcher tanks and related devices, systems, and methods are disclosed. A waterjet system configured in accordance with a particular embodiment includes a fluid-pressurizing device, a cutting head operably connected to the fluid-pressurizing device, and catcher tank. The cutting head is configured to direct a waterjet toward a workpiece via the waterjet outlet. The catcher tank has an internal volume configured to hold a pool of fluid such that the fluid is positioned relative to the workpiece so as to dissipate kinetic energy of the waterjet. The catcher tank includes a first tank section, a second tank section, and a sealing member. The first and second tank sections have first and second coupling surfaces, respectively, and are configured to be detachably coupled via the first and second coupling surfaces, respectively, to form a water-tight junction with the sealing member operably positioned within the junction.

### TECHNICAL FIELD

The present technology is related to, among other things, waterjet systems having sectional catcher tanks and related devices, systems, and methods.

### BACKGROUND

Waterjet systems (e.g., abrasive-jet systems) are used in precision cutting, shaping, carving, reaming, and other material-processing applications. During operation, waterjet systems typically direct a high-speed jet of fluid (e.g., water) toward a workpiece to rapidly erode portions of the workpiece. Abrasive material can be added to the fluid to increase the rate of erosion. When compared to other material-processing systems (e.g., grinding systems, flame-cutting systems, plasma-cutting systems, etc.) waterjet systems can have significant advantages. For example, waterjet systems often produce relatively fine and clean cuts without heat-affected zones around the cuts. Waterjet systems also are highly versatile with respect to the material type of the workpiece. The range of materials that can be processed using waterjet systems includes very soft materials (e.g., rubber, foam, leather, and paper) as well as very hard materials (e.g., stone, ceramic, and hardened metal). Furthermore, in many cases, waterjet systems are capable of executing demanding material-processing operations while generating little or no dust, smoke, and/or other potentially toxic byproducts.

In a typical waterjet system, a pump pressurizes fluid to a high pressure (e.g., 40,000 psi to 100,000 psi or more). Some of this pressurized fluid is routed through a cutting head that includes an orifice element having an orifice. The orifice element can be a hard jewel (e.g., a synthetic sapphire, ruby, or diamond) held in a suitable mount (e.g., a metal plate). Passing through the orifice converts static pressure of the fluid into kinetic energy, which causes the fluid to exit the cutting head as a jet at high speed (e.g., up to 2,500 feet-per-second or more) and impact a workpiece. After eroding through a portion of a workpiece, the waterjet can impact a pool of fluid within a catcher tank below the workpiece, thereby causing kinetic energy of the waterjet to dissipate. In many cases, a jig supports the workpiece. The jig, the cutting head, or both can be movable under computer and/or robotic control such that complex processing instructions can be executed automatically.

### BRIEF DESCRIPTION OF THE DRAWINGS

Many aspects of the present disclosure can be better understood with reference to the following drawings. The relative dimensions in the drawings may be to scale with respect to some embodiments. With respect to other embodiments, the drawings may not be to scale. For ease of reference, throughout this disclosure identical reference numbers may be used to identify identical or at least generally similar or analogous components or features.

FIG. 1A is an exploded perspective view illustrating a sectional catcher tank and associated components configured in accordance with an embodiment of the present technology.

FIG. 1B is an exploded perspective view illustrating a sectional catcher tank and associated components configured in accordance with another embodiment of the present technology.

FIG. 2 is cut-away perspective view illustrating a water-tight junction between adjacent tank sections of a sectional catcher tank configured in accordance with an embodiment of the present technology.

FIG. 3 is an enlarged cross-sectional end view taken along line 3-3 in FIG. 2.

FIGS. 4-8 are cross-sectional end views of water-tight junctions between adjacent tank sections of sectional catcher tanks configured in accordance with several embodiments of the present technology.

FIG. 9 is cut-away perspective view illustrating a water-tight junction between adjacent tank sections of a sectional catcher tank configured in accordance with an embodiment of the present technology.

FIG. 10 is an enlarged cross-sectional end view taken along line 10-10 in FIG. 9.

FIG. 11 is a cross-sectional end view of a water-tight junction between adjacent tank sections of a sectional catcher tank configured in accordance with another embodiment of the present technology.

FIG. 12 is a flow chart illustrating a method for making, using, and enlarging a waterjet system in accordance with an embodiment of the present technology.

### DETAILED DESCRIPTION

Specific details of several embodiments of the present technology are disclosed herein with reference to FIGS. 1A-12. Although the embodiments are disclosed herein primarily or entirely with respect to waterjet applications, other applications in addition to those disclosed herein are within the scope of the present technology. Furthermore, waterjet systems configured in accordance with embodiments of the present technology can be used with a variety of suitable fluids, such as water, aqueous solutions, hydrocarbons, glycol, and liquid nitrogen, among others. As such, although the term “waterjet” is used herein for ease of reference, unless the context clearly indicates otherwise, the term refers to a jet formed by any suitable fluid, and is not limited exclusively to water or aqueous solutions. It should be noted that other embodiments in addition to those disclosed herein are within the scope of the present technology. For example, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

In many applications, use of large-format waterjet systems can be advantageous relative to use of small-format waterjet systems. Large-format waterjet systems, for example, can have y-axis travels (e.g., travels parallel to a waterjet bridge) of about 125 inches or greater (e.g., from about 125 inches to about 250 inches), of about 150 inches or greater (e.g., from about 150 inches to about 250 inches), or other suitable y-axis travels. In addition or alternatively, large-format waterjet systems can have x-axis travels (e.g., travels perpendicular to a waterjet bridge) of about 250 inches or greater (e.g., from about 250 inches to about 1000 inches), of about 350 inches or greater (e.g., from about 350 inches to about 1000 inches), or other suitable x-axis travels. Among other advantages, use of large-format waterjet systems can enhance throughput, enhance operational efficiency (e.g., by facilitating workpiece staging), and/or expand the size range of workpieces that can be processed relative to smaller format waterjet systems. Furthermore, many of the more costly and complex components of waterjet systems (e.g., ultrahigh pressure pumps, controllers, user interfaces, etc.) often can serve large working areas as well as or nearly as well as small working areas. Thus, the total investment relative to processing capacity for large-format waterjet systems can be significantly less than for smaller format waterjet systems. This can be the case even for large-format waterjet systems that include two or more cutting heads, as the cutting heads can be served by shared system components.

Since the efficiencies and other advantages associated with large-format waterjet systems tend to be scalable, there has been a consistent demand for waterjet systems having larger and larger working areas. Creating these systems presents certain technical challenges. Due to the conditions in which waterjet catcher tanks are used, durability can be an important consideration. For example, although fluid within a catcher tank dissipates most of the kinetic energy of a waterjet during use, it can be difficult to prevent some eroding force from reaching the bottom and/or walls of a catcher tank holding the fluid. Conventional catcher tanks are typically made from steel plates welded together at the time of manufacturing and then shipped to customers in one piece. Although this approach is suitable for providing a durable catcher tank, some large-format catcher tanks may be too large to economically transport in one piece. Conventional steel plates can be welded together at an installation site to build a catcher tank, but this is also problematic since welding tends to be highly disruptive and precludes most customers from assembling purchased catcher tanks without the assistance of field technicians.

Catcher tanks configured in accordance with at least some embodiments of the present technology can at least partially overcome one or more of the disadvantages and technical challenges discussed above and/or one or more other disadvantages and/or technical challenges associated with conventional waterjet technology. For example, catcher tanks configured in accordance with at least some embodiments of the present technology can include two or more tank sections that are configured to be detachably coupled at a durable junction. The junction, for example, can include a sealing member (e.g., a gasket or flexible cord), that provides a water-tight seal between coupling surfaces of adjacent tank sections. Since sealing materials tend to be fragile relative to steel, the sealing members can be shielded or otherwise protected within the junctions from direct contact with a partially dissipated waterjet. Catcher tanks configured in accordance with at least some embodiments of the present technology can be transported to a customer in a decoupled state and then assembled relatively conveniently by a customer or a field technician at an installation site. Furthermore, the detachable connections between the tank sections can facilitate future retrofits (e.g., increasing or decreasing x-axis travel) as a customer's need for processing capacity changes over time.

FIG. 1A is a perspective view illustrating a sectional catcher tank 100 and associated components configured in accordance with an embodiment of the present technology. In the illustrated embodiment, the catcher tank 100 includes five tank sections 102 (individually identified as 102a-102e). In other embodiments, the catcher tank 100 can include another suitable number of tank sections 102 (e.g., two, three, four, six, seven, eight, or a greater number). The tank sections 102 can be configured to be moved into operable alignment and detachably coupled to form the catcher tank 100. For example, the individual tank sections 102 can include a pair of opposing wall sections 104, a floor section 108 extending therebetween, and one or two U-shaped coupling surfaces 106 along one or both combined U-shaped edges of the wall sections 104 and floor section 108 depending on whether the individual tank section 102 has an intermediate position (e.g., tank sections 102b-102d) or an end position (e.g., tank sections 102a, 102e). Opposing coupling surfaces 106 of adjacent tank sections 102 can be brought into alignment prior to or while the adjacent tank sections 102 are detachably coupled. When the tank sections 102 are detachably coupled, the catcher tank 100 can have an internal volume configured to hold a pool of fluid (not shown). The catcher tank 100 can also include workpiece supports 110 (e.g., rails, posts, beams, and/or other suitable support members) within the internal volume. When the workpiece supports 110 carry a workpiece (not shown), the pool of fluid can be suitably positioned relative to the workpiece so as to dissipate kinetic energy of a waterjet after the waterjet passes through the workpiece.

The opposing pairs of wall sections 104 can have opposite outer surfaces facing away from the internal volume. In some embodiments, the individual tank sections 102 include a pair of x-axis track sections 112 individually operably coupled to the individual wall sections 104, respectively, at the outer surfaces of the wall sections 104. In other embodiments, the x-axis track sections 112 can be separate from the wall sections 104 and/or non-sectional. As an example, the x-axis track sections 112 can configured to be floor mounted rather than mounted to the wall sections 104. As another example, the x-axis track sections 112 can be replaced with a non-sectional x-axis track section (not shown) configured to be floor mounted or mounted to the wall sections in one piece after assembly of the catcher tank 100. As another example, the x-axis track sections 112 can be sectional, but have different lengths along the x-axis than the wall sections 104. Other examples of suitable variations of the x-axis track sections 112 are also possible.

With reference again to FIG. 1A, moving the coupling surfaces 106 into operable alignment can cause the first and second pairs of x-axis track sections 112 also to move into operable alignment. A bridge 114 (shown schematically) can be configured to move along the x-axis track sections 112 to carry a cutting head 116 (also shown schematically) along the x-axis. The cutting head 116 can include a waterjet outlet 118 and can be operably connected to a fluid-pressurizing device 120 (e.g., a pump). The cutting head 116 can be configured to direct a waterjet toward a workpiece via the waterjet outlet 118. The opposing wall sections 104 can be spaced apart on either side of the internal volume by a suitable distance to support y-axis travel of the cutting head 116, such as large-format y-axis travel. In some embodiments, opposing wall sections 104 can be spaced apart by a distance greater than about 50 inches (e.g., from about 50 inches to about 250 inches), a distance greater than about 80 inches (e.g., from about 80 inches to about 250 inches), a distance greater than about 125 inches (e.g., from about 125 inches to about 250 inches), or another suitable distance when the tank sections 102 are detachably coupled.

FIG. 1B is an exploded perspective view illustrating a sectional catcher tank 150 and associated components configured in accordance with an embodiment of the present technology. The catcher tank 150 can include three independently controllable bridges 114 configured to move along the x-axis track sections 112. In other embodiments, the catcher tank 150 can include a smaller or greater number of bridges 114. The catcher tank 150 can further include compartmentalizing walls 109. The individual compartmentalizing walls 109 can be detachably coupled to adjacent tank sections 112 between coupling surfaces 106 of the adjacent tank sections 112. The compartmentalizing walls 109, for example, can be configured to separate the internal volume of the catcher tank 150 into compartments such that fluid levels within the compartments can be independently controlled. For example, the compartmentalizing walls 109 can be selectively positioned or not positioned between adjacent tank sections 112 along the x-axis so as to cause the catcher tank 150 to have any one of a number of different compartmentalized configurations. Compartmentalization using the compartmentalizing walls 109 can allow portions of the catcher tank 150 to be conveniently customized for different operations (e.g., staging, processing different sizes of materials, etc.) that demand various working areas and call for different fluid levels. While many of the junctions discussed below are discussed in the context of directly coupling tank sections, the same or similar concepts apply to coupling tank segments with intervening compartmentalizing walls.

FIG. 2 is cut-away perspective view illustrating a water-tight junction 200 between a first tank section 202 and an adjacent second tank section 204 of a sectional catcher tank configured in accordance with an embodiment of the present technology. FIG. 3 is an enlarged cross-sectional end view taken along line 3-3 in FIG. 2. With reference to FIGS. 2 and 3 together, the first tank section 202 can include a first floor section 205 and a first flange 206 extending away from the first floor section 205. Similarly, the second tank section 204 can include a second floor section 208 and a second flange 210 extending away from the second floor section 208. The first and second flanges 206, 210 can be integral with the first and second floor sections 205, 208, respectively. For example, the first and second flanges 206, 210 can meet the first and second floor sections 205, 208, respectively, at bends rather than joints. A first coupling surface 212 of the first tank section 202 extending along the first flange 206 can be configured to abut a second coupling surface 214 of the second tank section 204 extending along the second flange 210. In the illustrated embodiment, the junction 200 includes a weld 216 between the first and second coupling surfaces 212, 214. In other embodiments, the junction 200 can include another suitable type of coupling.

FIGS. 4-8 are cross-sectional end views of water-tight junctions between adjacent tank sections of sectional catcher tanks configured in accordance with several embodiments of the present technology. With reference to FIGS. 4 and 5, a first tank section 400 can include a first floor section 402 and a first flange 404 extending away from the first floor section 402. Similarly, the second tank section 406 can include a second floor section 408 and a second flange 410 extending away from the second floor section 408. The first and second flanges 404, 410 can be coupled to the first and second floor sections 402, 408, respectively. For example, the first and second flanges 404, 410 can be welded to the first and second floor sections 402, 408, respectively. The sectional catcher tank including the first and second tank sections 400, 406 can further include a sealing member 412 and a shield 413 configured to protect the sealing member 412 from being damaged by a partially dissipated waterjet. The shield 413 can be made of steel or another suitable shielding material. The sealing member 412 can be operably positioned within a water-tight junction 414 between a first coupling surface 416 extending along the first flange 404 and a second coupling surface 417 extending along the second flange 410. The shield 413, for example, can be configured to fit over uppermost portions of the first and second flanges 404, 410 and the sealing member 412. In some embodiments, the shield 413 is detachable. This can be useful, for example, to facilitate in situ repairs of the sealing member 412 and other repairs to and maintenance of components within the junction 414. In the embodiment illustrated in FIG. 4, the first and second flanges 404, 410 are configured to be clamped together with a clamp 418 to form the junction 414. In the embodiment illustrated in FIG. 5, the first and second flanges 404, 410 are configured to be bolted together with a bolt 420 and a nut 422 to form a water-tight junction 500. In other embodiments, the first and second flanges 404, 410 can be configured to be detachably joined in another suitable manner.

In the embodiments illustrated in FIGS. 4 and 5, the degree of compression on the sealing member 412 is variable. For example, adjusting the clamp 418 and the nut 422 can change a degree of compression on the sealing member 412 so as to achieve a suitable level of sealing within the junction 414. In other embodiments, a degree of compression on a sealing member 412 can be fixed. For example the compression can be limited by a rigid abutment. This can be useful, for example, to facilitate consistent installation, such as to cause a degree of compression determined to be advantageous (e.g., optimal) to be applied consistently along the length of the sealing member and among different installations. With reference to FIGS. 6-8, a first tank section 600 can include a first floor section 602 and a second tank section 604 can include a second floor section 606. The first and second floor sections 602, 606 can be configured to abut one another when the first and second tank sections 600, 604 are detachably coupled. For example, the first and second flanges 404, 410 can be attached (e.g., welded) to the first and second floor sections 602, 606, respectively, at set back positions relative to edges of the first and second floor sections 602, 606. When the first and second tank sections 600, 604 are detachably coupled, a first coupling surface 608 of the first tank section 600 and a second coupling surface 610 of the second tank section 604 can at least partially define a channel 612 configured to receive a sealing member 614. An upper portion of the channel 612 can be configured to at least partially receive a shield 616 (e.g., made of steel or another suitable shielding material). Similar to the shield 413 discussed above with reference to FIGS. 4 and 5, the shield 616 can be detachable or fixed. In the embodiment illustrated in FIG. 6, the first and second flanges 404, 410 are configured to be bolted together with a bolt 420 and a nut 422 when the first and second tank sections 600, 604 are detachably coupled. In the embodiment illustrated in FIG. 7, the first and second flanges 404, 410 are configured to be clamped together with a clamp 418 when the first and second tank sections 600, 604 are detachably coupled. In other embodiments, the first and second flanges 404, 410 can be configured to be detachably joined in another suitable manner.

In the embodiment shown in FIG. 7, the first and second flanges 404, 410 extend away from the first and second floor sections 602, 606, respectively, toward an internal volume (not shown) of the catcher tank when the first and second tank sections 600, 604 are detachably coupled. This can be useful, for example, to reduce or eliminate projections below the first and second floor sections 602, 606, such as to allow the first and second floor sections 602, 606 to be directly coupled to a floor rather than elevated over a floor on legs. As shown in FIG. 8, in other embodiments, the first and second flanges 404, 410 can extend away from the first and second floor sections 602, 606, respectively, and away the internal volume when the first and second tank sections 600, 604 are detachably coupled. This can be useful, for example, to allow portions of the first and second floor sections 602, 606 around abutting edges of the first and second floor sections 602, 606 to shield a sealing member 800. Thus, a detachable shield can be absent from the channel 612 and the sealing member 800 can at least generally fill the channel 612. In still other embodiments, flanges can extend both away from a side of the first and second floor sections 602, 606 facing toward the internal volume and away from an opposite side (e.g., the flanges can extend both above and below the first and second floor sections 602). This can be useful, for example, to increase the total sealing surface area.

FIG. 9 is cut-away perspective view illustrating a water-tight junction 900 between a first tank section 902 and an adjacent second tank section 904 of a sectional catcher tank configured in accordance with an embodiment of the present technology. FIG. 10 is an enlarged cross-sectional end view taken along line 10-10 in FIG. 9. With reference to FIGS. 9-10 together, the first tank section 900 can include a first floor section 906 and a first flange 908 extending away from the first floor section 906. Similarly, the second tank section 904 can include a second floor section 910 and a second flange 912 extending away from the second floor section 910. The first and second flanges 908, 912 can be integral with the first and second floor sections 906, 910, respectively. For example, the first and second flanges 908, 912 can meet the first and second floor sections 906, 910, respectively, at bends rather than joints. The first tank section 902 can include a first coupling surface 914 extending along the first flange 908, and the second tank section 910 can include a second coupling surface 916 extending along the second flange 912. The first and second tank sections 902, 904 can be configured to be moved into operable alignment and detachably coupled to form the junction 900 via the first and second coupling surfaces 914, 916, respectively, with a sealing member 918 operably positioned within the junction 900. For example, the first and second coupling surfaces 914, 916 can at least partially define a channel 922 configured to receive the sealing member 918 when the first and second tank sections 902, 904 are detachably coupled. A block clamp 920 can be configured to tighten around the junction 900. An inner region 924 of the first coupling surface 914 can be configured to abut an inner region 926 of the second coupling surface 916 at a portion of the junction 900 between the channel 922 and the internal volume when the first and second tank sections 902, 904 are detachably coupled. In this way, upper portions of the first and second flanges 908, 912 adjacent to the inner regions of the first and second coupling surfaces 914, 916 can at least partially shield the sealing member 918 from a partially dispersed waterjet.

As shown in FIGS. 4-8, in some embodiments, sealing members and associated channels can have generally rectangular cross sections perpendicular to their lengths. For example, the sealing members 412, 614, 616 can be flat gaskets. As shown in FIG. 9, in other embodiments, a sealing member 918 and an associated channel 922 can have round, oval or otherwise curved cross sections perpendicular to their lengths. For example, the sealing member 918 can be a cord. In some embodiments, a sealing member is configured to remain attached to an associated first or second coupling surface when adjacent first and second tank sections are decoupled. This can facilitate installation by reducing or eliminating the need to adjust the position of the sealing member during alignment of the first and section tank sections. In other embodiments, a sealing member can be configured to be independent of associated first and second coupling surfaces, which can facilitate replacement of the sealing member. Suitable materials for sealing members include, for example, rubber, high-density polymers, and closed-cell foams (e.g., silicone foams), among others. In some embodiments, a sealing member is configured to swell in the presence of water. For example, a sealing member can include a hydrophilic polymer (e.g., a hydrophilic acrylate polymer). Suitable swellable sealing members may include, for example, SIKASWELL® profiles available from Sika Services AG (Switzerland). As shown in FIG. 11, in some embodiments, a sealing member 1100 can be configured to swell mechanically alone or in addition to swelling chemically. For example, the sealing member 1100 can include an internal cavity 1102 configured to receive a pressurized fluid (e.g., air, water, or another suitable gaseous or liquid fluid). The internal cavity 1102 can be operably connected to a valve 1104 that can be closed to retain the pressurizing fluid within the cavity. The valve 1104 may be opened to bleed the pressurized fluid from the internal cavity and thereby reduce swelling of the sealing member 1100 or to allow pressurized fluid from an external source (not shown) to be introduced into the internal cavity to increase swelling of the sealing member 1100 as need (e.g., to address water leaks, to facilitate maintenance, etc.).

FIG. 12 is a flow chart illustrating a method 1200 for making, using, and enlarging a waterjet system in accordance with an embodiment of the present technology. The method 1200 can include transporting two or more tank sections toward an installation site in a decoupled state (block 1202). After transporting the tank sections, the method 1200 can include detachably coupling the tank sections at one or more water-tight junctions to form a catcher tank (block 1204). For example, the method 1200 can include bolting and/or clamping flanges of adjacent tank sections, operably aligning x-axis track sections of adjacent tank sections, and/or capturing a sealing member between coupling surfaces of adjacent tank sections. The catcher tank formed by detachably coupling the tank sections can also be operably associated with a waterjet cutting head (block 1206). The method 1200 can further include at least partially filling an internal volume of the catcher tank with fluid (block 1208). The water-tight junctions can prevent egress of the fluid from the internal volume. Next, kinetic energy of a waterjet can be dissipated via the fluid while shielding the sealing member from the waterjet (block 1210). The method 1200 can further include enlarging the catcher tank after detachably coupling the first and second tank sections by decoupling the first and second tank sections (block 1212) and detachably coupling one or more additional tank sections between the decoupled tank sections at two or more water-tight junctions (block 1214).

The method 1200 can also include other suitable operations. As an example, the method 1200 can include causing a sealing member to swell. For example, a pressurized fluid can be introduced into an internal cavity of a sealing member after detachably coupling first and second tank sections so as to cause the sealing member to swell. Alternatively or in addition, the sealing member can be exposed to water after detachably coupling the first and second tank sections so as to cause the sealing member to swell.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments can also exhibit such advantages, and not all embodiments need necessarily exhibit such advantages or other advantages disclosed herein to fall within the scope of the present technology. Accordingly, this disclosure and associated technology can encompass other embodiments not expressly shown or described herein.

The methods disclosed herein include and encompass, in addition to methods of practicing the present technology (e.g., methods of making and using the disclosed devices and systems), methods of instructing others to practice the present technology. For example, a method in accordance with a particular embodiment includes transporting a first tank section and a second tank section toward an installation site in a decoupled state, detachably coupling the first and second tank sections at a junction to form a catcher tank, at least partially filling an internal volume of the catcher tank with fluid, and diffusing kinetic energy of a waterjet via the fluid. A method in accordance with another embodiment includes instructing such a method.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout this disclosure to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

I/We claim:

1. A waterjet system, comprising:
a fluid-pressurizing device;
a cutting head operably connected to the fluid-pressurizing device, the cutting head including a waterjet outlet, the cutting head being configured to direct a waterjet toward a workpiece via the waterjet outlet; and
a catcher tank having an internal volume configured to hold a pool of fluid such that the fluid is positioned relative to the workpiece so as to dissipate kinetic energy of the waterjet after the waterjet passes through the workpiece, the catcher tank including—
a first tank section having a first coupling surface,
a second tank section having a second coupling surface, and
a sealing member,
wherein the first and second tank sections are configured to be detachably coupled via the first and second coupling surfaces, respectively, to form a water-tight junction with the sealing member operably positioned within the junction.

2. The waterjet system of claim 1 wherein:
the first tank section includes a pair of opposing first wall sections configured to be spaced apart on either side of the internal volume by a distance from about 125 inches to 250 inches when the first and second tank sections are detachably coupled; and
the second tank section includes a pair of opposing second wall sections configured to be spaced apart on either side of the internal volume by a distance from about 125 inches to 250 inches when the first and second tank sections are detachably coupled.

3. The waterjet system of claim 1 wherein the sealing member is configured to swell in the presence of water.

4. The waterjet system of claim 1 wherein the sealing member includes a hydrophilic polymer.

5. The waterjet system of claim 1 wherein the sealing member includes an internal cavity configured to receive a pressurized fluid so as to cause the sealing member to swell.

6. The waterjet system of claim 1, further comprising a compartmentalizing wall configured to be detachably coupled to the first and second tank sections between the first and second coupling surfaces, the compartmentalizing wall being configured to separate the internal volume such that fluid levels within portions of the internal volume at opposite sides of the compartmentalizing wall are independently controllable.

7. The waterjet system of claim 1 wherein the first and second coupling surfaces at least partially define a channel configured to receive the sealing member when the first and second tank sections are detachably coupled.

8. The waterjet system of claim 7 wherein an inner region of the first coupling surface and an inner region of the second coupling surface are configured to abut one another at a portion of the junction between the channel and the internal volume when the first and second tank sections are detachably coupled.

9. The waterjet system of claim 7, further comprising a detachable shield, wherein an upper portion of the channel between the sealing member and the internal volume is configured to at least partially receive the shield when the first and second tank sections are detachably coupled.

10. The waterjet system of claim 7 wherein:
the first tank section includes a first floor section and a first flange extending away from the first floor section;
the first coupling surface extends along the first flange;
the second tank section includes a second floor section and a second flange extending away from the second floor section;
the second coupling surface extends along the second flange; and
the first and second flanges are configured to be bolted and/or clamped together when the first and second tank sections are detachably coupled.

11. The waterjet system of claim 10 wherein the first and second flanges extend away from the first and second floor sections, respectively, toward an internal volume of the catcher tank when the first and second tank sections are detachably coupled.

12. The waterjet system of claim 10 wherein the first and second flanges extend away from the first and second floor sections, respectively, and away an internal volume of the catcher tank when the first and second tank sections are detachably coupled.

13. The waterjet system of claim 10 wherein the first and second floor sections are configured to abut one another when the first and second tank sections are detachably coupled.

14. A waterjet system, comprising:
a fluid-pressurizing device;
a cutting head operably connected to the fluid-pressurizing device, the cutting head including a waterjet outlet, the cutting head being configured to direct a waterjet toward a workpiece via the waterjet outlet; and
a catcher tank having an internal volume configured to hold a pool of fluid such that the fluid is positioned relative to the workpiece so as to dissipate kinetic energy of the waterjet after the waterjet passes through the workpiece, the catcher tank including—
a first tank section having a pair of opposing first wall sections, a first floor section extending between the first wall sections, and a first flange extending away from the first floor section,
a second tank section having a pair of opposing second wall sections, a second floor section extending between the second wall sections, and a second flange extending away from the second floor section,
a sealing member, and
a compartmentalizing wall configured to be detachably coupled to the first and second tank sections between the first and second coupling surfaces, the compartmentalizing wall being configured to separate the internal volume such that fluid levels within portions of the internal volume at opposite sides of the compartmentalizing wall are independently controllable,
wherein—
the first tank section includes a U-shaped first coupling surface extending along the first flange,
the second tank section includes a U-shaped second coupling surface extending along the second flange,
the first and second tank sections are configured to be moved into operable alignment and detachably coupled to form a water-tight junction via the first and second coupling surfaces, respectively, with the sealing member operably positioned within the junction,
the first and second coupling surfaces at least partially define a channel configured to receive the sealing member when the first and second tank sections are detachably coupled,
the first and second flanges are configured to be bolted and/or clamped together when the first and second tank sections are detachably coupled,
the first wall sections are configured to be spaced apart on either side of the internal volume by a distance from about 125 inches to 250 inches when the first and second tank sections are detachably coupled, and
the second wall sections are configured to be spaced apart on either side of the internal volume by a distance from about 125 inches to 250 inches when the first and second tank sections are detachably coupled.

15. A method, comprising:
transporting a first tank section and a second tank section toward an installation site in a decoupled state;
detachably coupling the first and second tank sections at a water-tight junction to form a catcher tank after transporting the first and second tank sections, the junction including a sealing member operably positioned between a first coupling surface of the first tank section and a second coupling surface of the second tank section; and
operably associating the catcher tank with a waterjet cutting head.

16. The method of claim 15 wherein detachably coupling the first and second tank sections includes bolting a first flange of the first tank section to a second flange of the second tank section.

17. The method of claim 15 wherein detachably coupling the first and second tank sections includes clamping a first flange of the first tank section to a second flange of the second tank section.

18. The method of claim 15, further comprising enlarging the catcher tank after detachably coupling the first and second tank sections, enlarging the catcher tank including:
decoupling the first and second tank sections; and
detachably coupling one or more additional tank sections between the first and second tank sections at two or more water-tight junctions to form an enlarged catcher tank.

19. The method of claim 15, further comprising:
at least partially filling an internal volume of the catcher tank with fluid, the junction being configured to prevent egress of the fluid from the internal volume; and
diffusing kinetic energy of a waterjet via the fluid.

20. The method of claim 15 wherein detachably coupling the first and second tank sections includes detachably coupling a compartmentalizing wall to the first and second tank sections between the first and second coupling surfaces.

21. The method of claim 20 further comprising independently controlling fluid levels within portions of an internal volume of the catcher tank at opposite sides of the compartmentalizing.

22. The method of claim 15 wherein detachably coupling the first and second tank sections includes capturing a sealing member between a first coupling surface of the first tank section and a second coupling surface of the second tank section.

23. The method of claim 22, further comprising exposing the sealing member to water after detachably coupling the first and second tank sections so as to cause the sealing member to swell.

24. The method of claim 22, further comprising shielding the sealing member from the waterjet while diffusing kinetic energy of the waterjet via the fluid.

25. The method of claim 22, further comprising introducing a pressurized fluid into an internal cavity of the sealing member after detachably coupling the first and second tank sections so as to cause the sealing member to swell.
